(19) United States
(12) Patent Application Publication
(10) Pub. No.: US 2019/0057155 A1
(43) Pub. Date: Feb. 21, 2019

(54) Method for discovering and contacting users of a mobile application

(71) Applicant: Hadif Hamad Mehad Mohamed Almheiri, Sharjah (AE)

(72) Inventor: Hadif Hamad Mehad Mohamed Almheiri, Sharjah (AE)

(21) Appl. No.: 15/680,224

(22) Filed: Aug. 18, 2017

(51) Int. Cl. G06F 17/30; H04L 12/58

(52) U.S. Cl. CPC G06F 17/30867; H04L 63/20; H04L 51/32

(57) ABSTRACT

In one embodiment, the present invention is a mobile application that asks a user to verify his user phone number, requests the user to activate his user account, requests the user to add information about himself, requests the user to add information about his interests, requests the user to adjust his privacy settings, allows the user to discover other users, allows the user to view the profiles of other users, allows the user to view other users on a map, allows the user to contact other users, allows the user to view messages sent by other users, and allows the user to chat with individual users.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to the field of mobile applications using location information. At least two patented inventions relate to mobile applications using the location information. U.S. Pat. No. 9,125,000 by LaMarca, et al. provides for location-aware mobile application management. U.S. Pat. No. 9,247,386 by Kau, et al. by provides for location-based mobile application and service selection. None of these inventions allow their users to discover and contact users of mobile applications. There is a pressing social need for an invention that can be used for discovering and contacting users of a mobile application. The present invention fills the aforementioned gaps in the prior art.

Relevant prior art includes:

U.S. Pat. No. 9,125,000 by LaMarca

U.S. Pat. No. 9,247,386 by Kau, et al.

### SUMMARY OF THE INVENTION

The present invention is a mobile application that, after being installed and activated on a mobile device, asks a user to verify his user phone number. When the user verifies his user phone number, the invention requests the user to activate his user account. When the user activates his user account, the invention requests the user to add information about himself. When the user adds information about himself, the invention requests the user to add information about his interests. When the user adds information about his interests, the invention requests the user to adjust his privacy settings. When the user adjusts his privacy settings, the invention allows the user to discover other users. When the user discovers other users, the invention allows the user to view the profiles of the other users. When the user views the profiles of other users, the invention allows the user to view other users on a map. When the user views other users on a map, the invention allows the user to contact other users. When the user contacts other users, the invention allows the user to view messages sent by other users. When the user views messages sent by other users, the invention allows the user to chat with individual users.

### BRIEF DESCRIPTION OF THE DRAWINGS

FIG. 1 is a flowchart of an exemplary process of operation of the invention

FIG. 2 is an exemplary user interface allowing the user of the invention to verify his number

FIG. 3 is an exemplary user interface allowing the user of the invention to activate his account

FIG. 4 is an exemplary user interface allowing the user of the invention to add user information

FIG. 5 is an exemplary user interface allowing the user of the invention to add user interests

FIG. 6 is an exemplary user interface allowing the user of the invention to set privacy rules applying to his use of the invention

FIG. 7 is an exemplary user interface allowing the user of the invention to discover other users of the invention

FIG. 8 is an exemplary user interface allowing the user of the invention to see the profile of another user of the invention

FIG. 9 is an exemplary user interface allowing the user of the invention to see the location of other users of the invention on a map

FIG. 10 is an exemplary user interface allowing the user of the invention to contact other users

FIG. 11 is an exemplary user interface allowing the user of the invention to view chat messages sent by other users of the invention

FIG. 12 is an exemplary user interface allowing the user of the invention to chat with individual users

### DRAWINGS—REFERENCE NUMERALS

2—start of the exemplary process of operation of the invention

4—verifying user phone number

6—activating user account

8—adding user information

10—adding user interests

12—adjusting privacy settings

14—discovering other users

16—viewing the profiles of other users

18—viewing other users on a map

20—contacting other users

22—viewing chat messages sent by other users

24—chatting with individual users

26—end of the exemplary process of operation of the invention

27—an exemplary user interface allowing the user of the invention to verify his phone number

28—a section containing the text “Verify your phone number”

30—a scrollable field allowing the user of the invention to choose the country of his residence

32—a Tillable field allowing the user of the invention to add his phone number

34—exemplary text “We will send you a code by SMS to this phone number. Please make

sure you can receive SMS at this number”

36—a button “send verification code”

38—an exemplary user interface allowing the user of the invention to activate his account

40—a section containing the text “Activate your account”

42—a fillable field allowing the user of the invention to enter a code which will activate his account

44—exemplary text “Please type the verification code”

46—button “Verify”

48—an exemplary user interface allowing the user of the invention to add user information

50—a section containing the text “User information”

52—a button “Upload a profile picture” allowing the user of the invention to upload his photo

54—a fillable field “Enter your name” allowing the user of the invention to enter his name

56—a section allowing the user of the invention to choose his gender

58—a section allowing the user of the invention to select his date of birth

60—exemplary text “What is your nationality?”

62—a scrollable field allowing the user of the invention to choose his nationality

64—exemplary text “Choose your profession”

66—a scrollable field allowing the user of the invention to choose his profession

68—a fillable field allowing the user of the invention to enter his email address

70—a button “Next” which allows the user of the invention to move to the next interface

72—an exemplary user interface allowing the user of the invention to add user interests

74—a section containing the text “User interests”

76—a checkbox list of interests

78—an exemplary user interface allowing the user of the invention to set privacy rules applying to his use of the invention

80—a button “Save”

82—a button “Privacy”

84—a section containing the text “Privacy rules”

86—a section allowing the user to turn on or off the alien mode

88—a section allowing the user of the invention to choose whether to add another user to the contact list if the number of the other user is in the address book of the user of the invention

90—a section allowing the user of the invention to choose between “Male” or “Female” discovery preference

92—a section allowing the user to choose age preference

94—a section allowing the user to choose nationality preference

96—a section allowing the user to choose interests preference

98—a section allowing the user to choose whether to hide his location on a map

100—a section allowing the user of the invention to activate or deactivate the appearance of pop up notifications

102—a section allowing the user of the invention to hide his mobile number

104—a section allowing the user of the invention to hide his date of birth

106—an exemplary user interface allowing the user of the invention to discover other users of the invention

108—a photo of the user of the invention

110—a button “map”

112—a button “Discovered”

114—a button “Contact”

116—a field indicating the number of unread messages

118—a button redirecting the user of the invention to an exemplary user interface allowing the user of the invention to view chat messages sent by other users of the invention

120—a section allowing the user of the invention to see information about a user of the invention called Kathy

122—a section allowing the user of the invention to see information about a user of the invention called Charlie

124—a section allowing the user of the invention to see information about a user of the invention called Andre

126—an exemplary user interface allowing the user of the invention to see the profile of another user of the invention

128—a photo of another user of the invention

130—a section containing the text “My Profile”

132—the name and the occupation of the user whose profile is being viewed

134—an email address of the user whose profile is being viewed

136—a phone number of the user whose profile is being viewed

138—the date of birth of the user whose profile is being viewed

140—the nationality of the user whose profile is being viewed

142—the interests of the user whose profile is being viewed

144—an exemplary user interface allowing the user of the invention to see the location of other users of the invention on a map

146—a sign indicating the location of another user of the invention

148—a map of the region in which the user of the invention resides

150—an exemplary user interface allowing the user of the invention to contact other users

152—a section allowing the user of the invention to contact another user of the invention called Katherine Williams

154—a section allowing the user of the invention to contact another user of the invention called Charlie Smith

156—a section allowing the user of the invention to contact another user of the invention called Andre Brown

158—an exemplary user interface allowing the user of the invention to view chat messages sent by other users of the invention

160—a section allowing the user of the invention to view chat messages sent by a user of the invention called Kathy

162—a section allowing the user of the invention to view chat messages sent by a user of the invention called Charlie

164—a section allowing the user of the invention to view chat messages sent by a user of the invention called Andre

166—an exemplary user interface allowing the user of the invention to chat with an individual user called Kathy

168—a section containing the name of an individual user

170—an exemplary chat message sent by another user of the invention

172—an exemplary chat message sent by the user of the invention

174—a Tillable field allowing the user to type a message

176—a button “Send” allowing the user to send a message

### DETAILED DESCRIPTION OF THE INVENTION

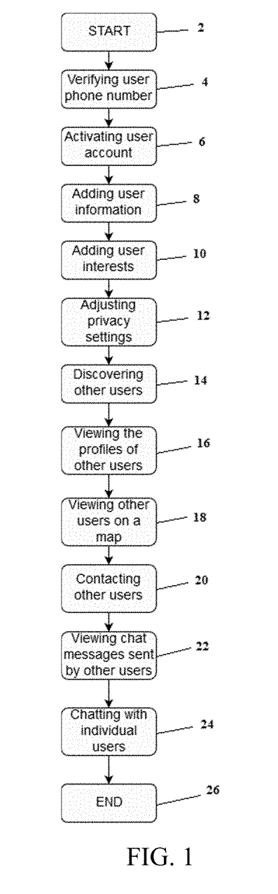

Referring now to the invention in more detail, in FIG. 1 there is shown a flow chart of an exemplary process of operation of the invention consisting of the following steps: start of the exemplary process of operation of the invention 2, verifying user phone number 4, activating user account 6, adding user information 8, adding user interests 10, adjusting privacy settings 12, discovering other users 14, viewing the profiles of other users 16, viewing other users on a map 18, contacting other users 20, viewing chat messages sent by other users 22, chatting with individual users 24, end of the exemplary process of operation of the invention 26.

In more detail, still referring to the invention of FIG. 1, the exemplary process of operation of the invention starts at step 2. At step 4, the user of the invention verifies his phone number. At step 6, the user of the invention activates his user account. At step 8, the user of the invention adds user information about himself. At step 10, the user of the invention adds information about his interests. At step 12, the user of the invention adjusts the privacy settings of the invention. At step 14, the user of the invention discovers other users. At step 16, the user of the invention views other users on a map. At step 20, the user of the invention contacts other users. At step 22, the user of the invention views chat messages sent by other users. At step 24, the user of the inventions chats with individual users. At step 26, the exemplary process of operation of the invention ends.

In one embodiment of the invention, the user of the invention is a person searching for service providers and, at step 14, the user of the invention discovers other users who are service providers. In one embodiment of the invention, in order to discover other users who are service providers, the user of the invention has to type the name of the service he is looking for in a field called “Service Title”. In one embodiment of the invention, in order to discover other users who are service providers, the user of the invention needs to choose a city in which the service providers are based. For example, the user of the invention can choose one or more cities out of a predefined list of cities. In one embodiment of the invention, the user of the invention is a person searching for service providers and, at step 14, the user of the invention discovers other users who are service providers located within a distance of no more than 10 kilometers from the city chosen by the user of the invention. Such service providers may include, for example, movers, gardeners, companies providing home maintenance services, and companies providing car recovery services. In one embodiment of the invention, service providers willing to be able to be discovered by users of the invention need to pay monthly fees to the operator of the invention. In one embodiment of the invention, at step 14, the user of the invention discovers other users who are service providers located within a predefined region or a region specified by the user of the invention. In one embodiment of the invention, the user of the invention can specify such a region by tapping with a finger the screen of a mobile phone and drawing a circle.

In one embodiment of the invention, at step 14, the user of the invention discovers other users who are service providers located within a radius specified by the user.

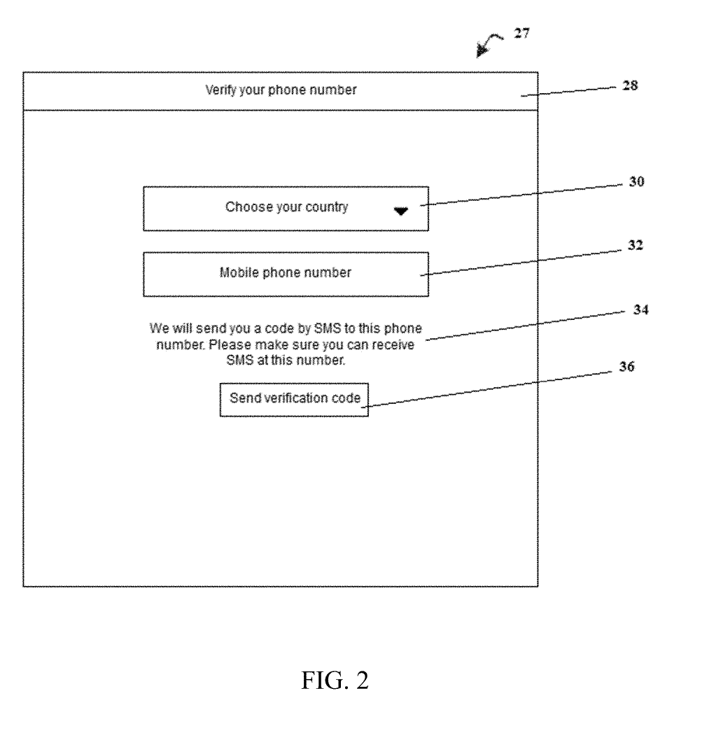

Referring now to the invention in more detail, in FIG. 2 there is shown an exemplary user interface allowing the user of the invention to verify his phone number 27. The exemplary user interface allowing the user of the invention to verify his phone number 27 includes a section containing the text “Verify your phone number” 28, a scrollable field allowing the user of the invention to choose the country of his residence 30, a fillable field allowing the user of the invention to add his phone number 32, exemplary text “We will send you a code by SMS to this phone number. Please make sure you can receive SMS at this number” 34, and a button “send verification code” 36.

In more detail, still referring to the invention of FIG. 2, the section containing the text “Verify your phone number” 28 clearly indicates that the user of the invention needs to verify his phone number by using the exemplary user interface allowing the user of the invention to verify his phone number 27. To verify his phone number by using the exemplary user interface allowing the user of the invention to verify his phone number 27, the user of the invention needs to choose a country by using the scrollable field allowing the user of the invention to choose the country of its residence 30 and enter a phone number in the fillable field allowing the user of the invention add his phone number 32. After receiving a code as stated in the exemplary text “We will send you a code by SMS to this phone number. Please make sure you can receive SMS at this number” 34, the user of the invention needs to press on the button “send verification code” 36.

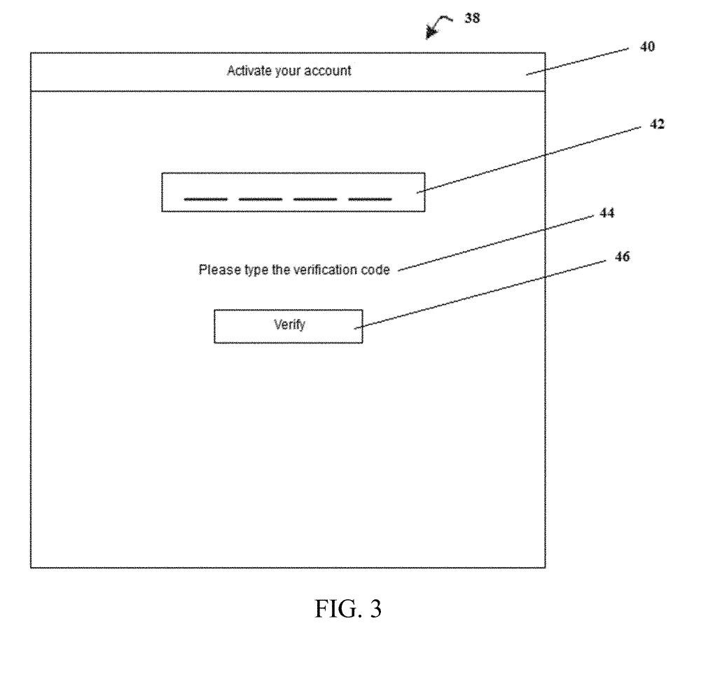

Referring now to the invention in more detail, in FIG. 3 there is shown an exemplary user interface allowing the user of the invention to activate his account 38. The exemplary user interface allowing the user of the invention to activate his account 38 includes a section containing the text “Activate your account” 40, a fillable field allowing the user of the invention to enter a code which will activate his account 42, exemplary text “Please type the verification code” 44, and a button “Verify” 46.

In more detail, still referring to the invention of FIG. 3, the section containing the text “Activate your account” 40 clearly indicates that the user of the invention needs to activate his user account by using the exemplary user interface allowing the user of the invention to activate his account 38. To do so, the user of the invention needs to follow the instructions in the exemplary text “Please type the verification code” 44 and enter a code in the fillable field allowing the user of the invention to enter a code which will activate his account 42. Afterwards, the user of the invention needs to click on the button “Verify” 46.

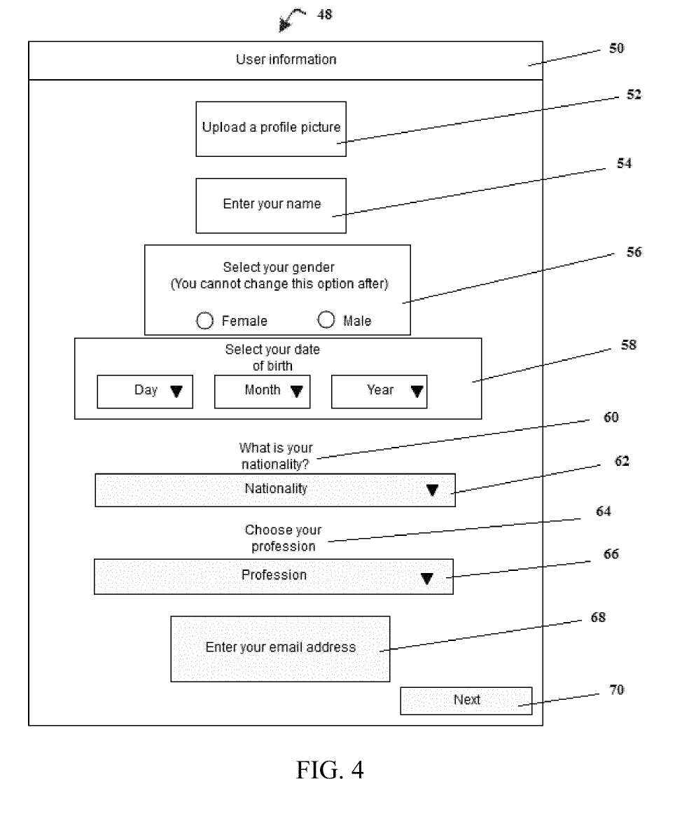

Referring now to the invention in more detail, in FIG. 4 there is shown an exemplary user interface allowing the user of the invention to add user information 48. The exemplary user interface allowing the user of the invention to add user information 48 includes a section containing the text “User information” 50, a button “Upload a profile picture” allowing the user of the invention to upload his photo 52, a fillable field “Enter your name” allowing the user of the invention to enter his name 54, a section allowing the user of the invention to choose his gender 56, a section allowing the user of the invention to select his date of birth 58, exemplary text “What is your nationality?” 60, a scrollable field allowing the user of the invention to choose his nationality 62, exemplary text “Choose your profession” 64, a scrollable field allowing the user of the invention to choose his profession 66, a fillable field allowing the user of the invention to enter his email address 68, a button “Next” which allows the user of the invention to move to the next interface 70.

In more detail, still referring to the invention of FIG. 4, the section containing the text “User information” 50 clearly indicates that the user of the invention needs to add user information by using the exemplary user interface allowing the user of the invention to add user information 48. By clicking on the button “Upload a profile picture” allowing the user of the invention to upload his photo 52, the user of the invention can upload his photo to his user account. The fillable field “Enter your name” allowing the user of the invention to enter his name 54 can be used by the user of the invention to add his name to his user account. The section allowing the user of the invention to choose his gender 56 can be used by the user of the invention to add his name to his user account. The section allowing the user of the invention to select his date of birth 58 can be used by the user of the invention to select the day, the month, and the year of his birth. The scrollable field allowing the user of the invention to choose his nationality 62 located under the exemplary text “What is your nationality?” 60 can be used by the user of the invention to select one out of many predefined nationality fields. The scrollable field allowing the user of the invention to choose his profession 66 located under the exemplary text “Choose your profession” 64 can be used by the user of the invention to choose one out of many predefined professions. The fillable field allowing the user of the invention to enter his email address 68 can be used by the user of the invention to add his email address to his user account. The button “Next” which allows the user of the invention to move to the next interface 70 can be used by the user of the invention to go to the exemplary user interface allowing the user of the invention to add user interests 72.

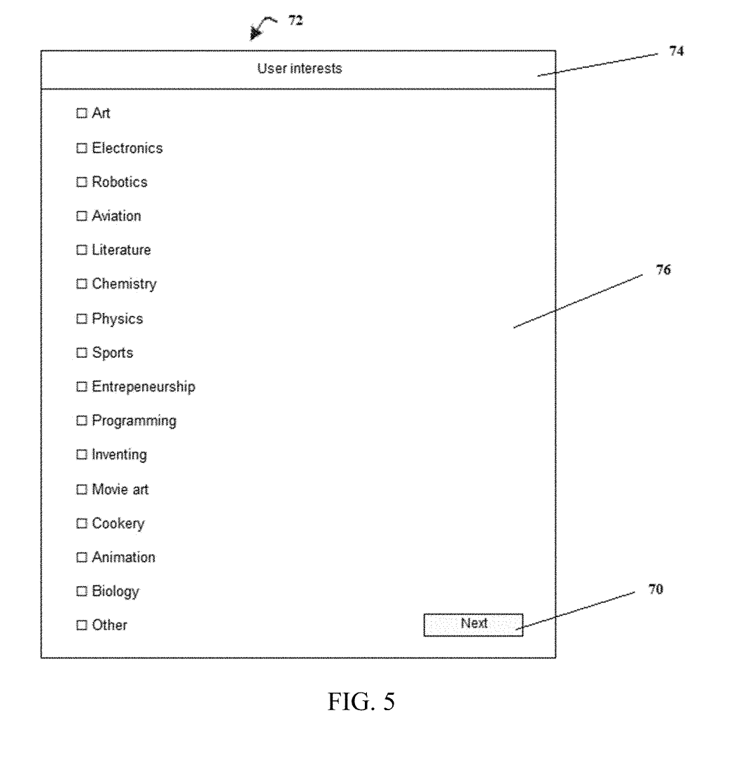

Referring now to the invention in more detail, in FIG. 5 there is shown an exemplary user interface allowing the user of the invention to add user interests 72. The exemplary user interface allowing the user of the invention to add user interests 72 includes a button “Next” which allows the user of the invention to move to the next interface 70, a section containing the text “User interests” 74, a checkbox list of interests 76.

In more detail, still referring to the invention of FIG. 5, the section containing the text “User interests” 74 clearly indicates that the user of the invention needs to add his user interests by using the exemplary user interface allowing the user of the invention to add user interests 72. The user of the invention can add his user interests by using the checkbox list of interests 76. In one embodiment of the invention, the checkbox list of interests contains the following interests: Art, Electronics, Robotics, Aviation, Literature, Chemistry, Physics, Sports, Entrepreneurship, Programming, Inventing, Movie art, Cookery, Animation, Biology, and Other. After the user of the invention chooses the relevant user interests, he needs to press the button “Next” which allows the user of the invention to move to the next interface 70.

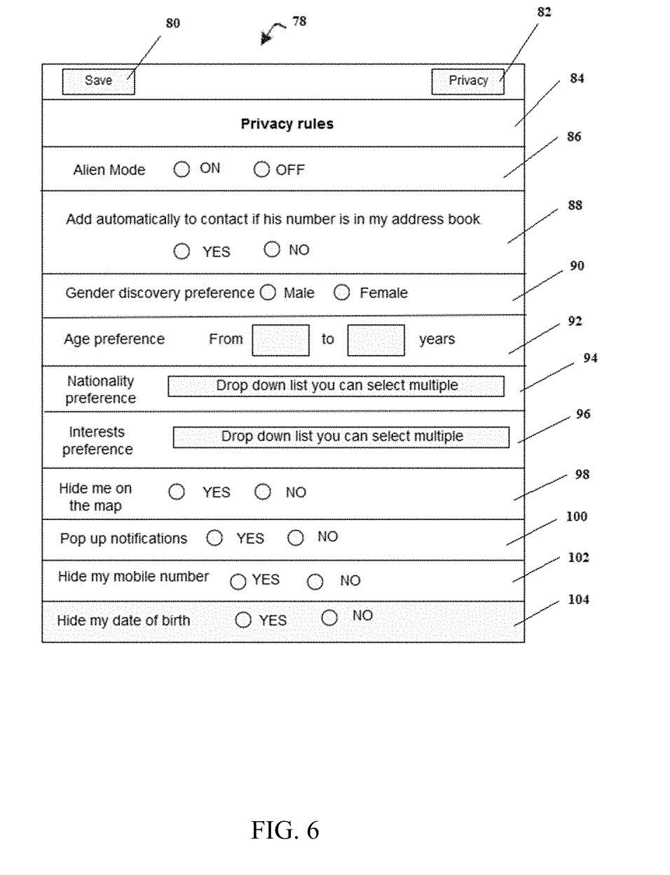

Referring now to the invention in more detail, in FIG. 6 there is an exemplary user interface allowing the user of the invention to set privacy rules applying to his use of the invention 78. The exemplary user interface allowing the user of the invention to set privacy rules applying to his use of the invention 78 includes a button “Save” 80, a button “Privacy” 82, a section containing the text “Privacy rules” 84, a section allowing the user to turn on or off the alien mode 86, a section allowing the user of the invention to choose whether to add another user to the contact list if the number of the other user is in the address book of the user of the invention 88, a section allowing the user of the invention to choose between “Male” or “Female” discovery preference 90, a section allowing the user to choose age preference 92, a section allowing the user to choose nationality preference 94, a section allowing the user to choose interests preference 96, a section allowing the user to choose whether to hide his location on a map 98, a section allowing the user of the invention to activate or deactivate the appearance of pop up notifications 100, a section allowing the user of the invention to hide his mobile number 102, a section allowing the user of the invention to hide his date of birth 104.

In more detail, still referring to the invention of FIG. 6, a button “Save” 80 allows the user of the invention to save the changes of the privacy settings made through the exemplary user interface allowing the user of the invention to set privacy rules applying to his use of the invention 78. The button “Privacy” 82 allows the user of the invention to go to the exemplary user interface allowing the user of the invention to set privacy rules applying to his use of the invention 78. The section containing the text “Privacy rules” 84 clearly indicates the title of the exemplary user interface allowing the user of the invention to set privacy rules applying to his use of the invention 78. The section allowing the user to turn on or off the alien mode 86 enables the user of the invention not to be discovered by other users of the invention. The section allowing the user of the invention to choose whether to add another user to the contact list if the number of the other user is in the address book of the user of the invention 88 enables the user of the invention to automatically add another user to his contact list if one condition is met, namely, the phone number of the other user should be included in the address book of the user of the invention. The section allowing the user of the invention to choose between “Male” or “Female” discovery preference 90 enables the user of the invention to choose the gender of the users he wants to discover. The section allowing the user to choose age preference 92 enables the user of the invention to choose the age range of the users he wants to discover. The section allowing the user to choose nationality preference 94 enables the user of the invention to choose the nationality of the users of the invention he wants to discover. More specifically, the section allowing the user to choose nationality preference 94 enables the user of the invention to choose one or more nationalities out of a predefined list of nationalities. The section allowing the user to choose interests preference 96 enables the user of the invention to choose one or more interests out of a predefined list of interests. The section allowing the user to choose whether to hide his location on a map 98 allows the user to hide his location on a map viewed by other users of the invention. The section allowing the user of the invention to activate or deactivate the appearance of pop up notifications 100 enables the user of the invention to choose whether or not receive pop up notifications, such as notifications about messages sent by other users. The section allowing the user of the invention to hide his mobile number 102 enables the user of the invention to hide his mobile number from other users of the invention. The section allowing the user of the invention to hide his date of birth 104 enables the user of the invention to hide his date of birth from other users of the invention.

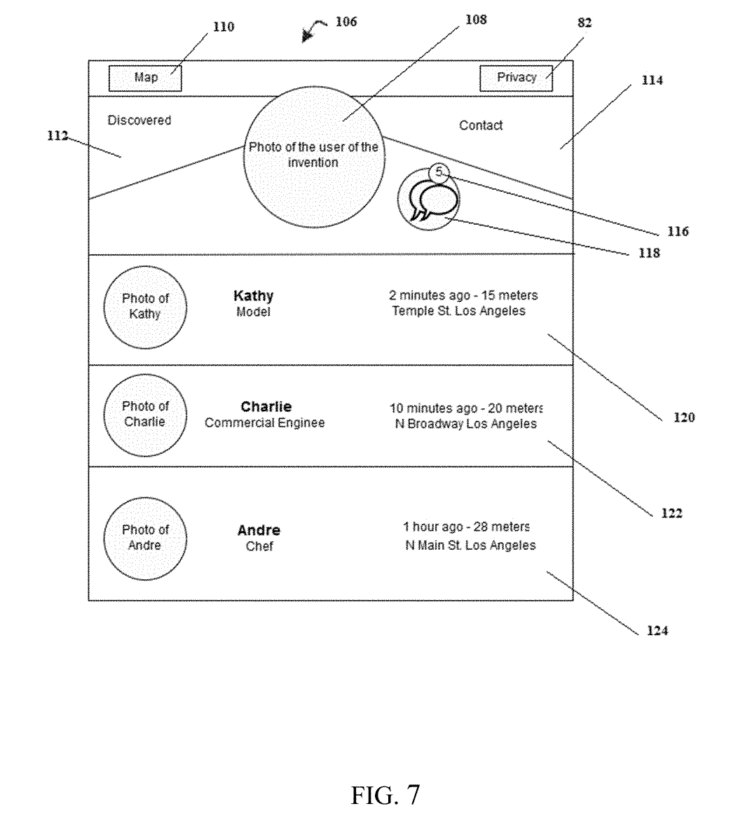

Referring now to the invention in more detail, in FIG. 7 there is an exemplary user interface allowing the user of the invention to discover other users of the invention 106. The exemplary user interface allowing the user of the invention to discover other users of the invention 106 includes a button “Privacy” 82, a photo of the user of the invention 108, a button “map” 110, a button “Discovered” 112, a button “Contact” 114, a field indicating the number of unread messages 116, a button redirecting the user of the invention to an exemplary user interface allowing the user of the invention to view chat messages sent by other users of the invention 118, a section allowing the user of the invention to see information about a user of the invention called Kathy 120, a section allowing the user of the invention to see information about a user of the invention Charlie 122, a section allowing the user of the invention to see information about a user of the invention called Andre 124.

In more detail, still referring to the invention of FIG. 7, the button “map” 110 and the button “Privacy” 82 are located on the top of the exemplary user interface allowing the user of the invention to discover other users of the invention 106. If the user of the invention clicks on the button “map” 110, he will be redirected to the exemplary user interface allowing the user of the invention to see the location of other users of the invention on a map 144. If the user of the invention clicks on the button “Privacy” 82, he will be redirected to the exemplary user interface allowing the user of the invention to set privacy rules applying to his use of the invention 78. The photo of the user of the invention 108 can be either in black and white or color. If the user of the invention clicks on the button “Discovered” 112, he will remain viewing the exemplary user interface allowing the user of the invention to discover other users of the invention 106. If the user of the invention clicks on the button “Contact” 114, he will be redirected to the exemplary user interface allowing the user of the invention to contact other users 150. The field indicating the number of unread messages 116 shows the number of unread messages which are received by the user of the invention. For example, if the user has five unread messages, the field indicating the number of unread messages 116 will show the number 5. If the user of the invention clicks on the button redirecting the user of the invention to an exemplary user interface allowing the user of the invention to view chat messages sent by other users of the invention 118, the user of the invention will be redirected to the exemplary user interface allowing the user of the invention to view chat messages sent by other users of the invention 158. The section allowing the user of the invention to see information about a user of the invention called Kathy 120 contains a photo of an exemplary user called Kathy, the name of the exemplary user called Kathy, the occupation of Kathy, the distance between Kathy and the user of the invention, and the location of Kathy. The section allowing the user of the invention to see information about a user of the invention called Charlie 122 contains a photo of an exemplary user called Charlie, the name of the exemplary user called Charlie, the occupation of Charlie, the distance between Charlie and the user of the invention, and the location of Charlie. The section allowing the user of the invention to see information about a user of the invention called Andre 124 contains a photo of an exemplary user called Andre, the name of the exemplary user called Andre, the occupation of Andre, the distance between Andre and the user of the invention, and the location of Andre.

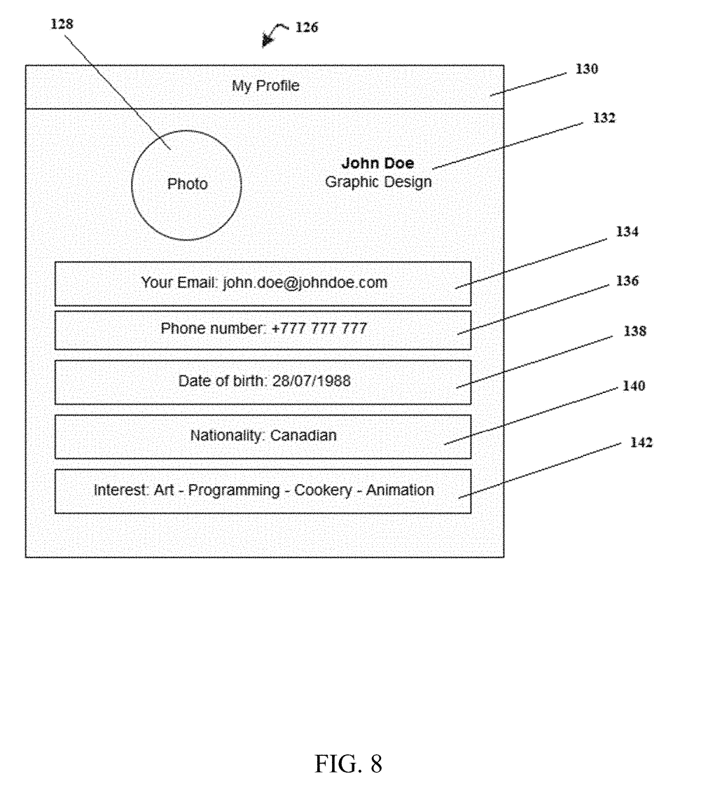

Referring now to the invention in more detail, in FIG. 8 there is an exemplary user interface allowing the user of the invention to see the profile of another user of the invention 126. The exemplary user interface allowing the user of the invention to see the profile of another user of the invention 126 includes a photo of another user of the invention 128, a section containing the text “My Profile” 130, the name and the occupation of the user whose profile is being viewed 132, an email address of the user whose profile is being viewed 134, a phone number of the user whose profile is being viewed 136, the date of birth of the user whose profile is being viewed 138, the nationality of the user whose profile is being viewed 140, the interests of the user whose profile is being viewed 142.

In more detail, still referring to the invention of FIG. 8, the section containing the text “My Profile” 130 clearly indicates the title of the exemplary user interface allowing the user of the invention to see the profile of another user of the invention 126. The photo of another user of the invention 128 can be either in black and white or color. Under the photo of another user of the invention 128, the user of the invention can find the name and the occupation of the user whose profile is being viewed 132, the email address of the user whose profile is being viewed 134, a phone number of the user whose profile is being viewed 136, the date of birth of the user whose profile is being viewed 138, the nationality of the user whose profile is being viewed 140, the interests of the user whose profile is being viewed 142.

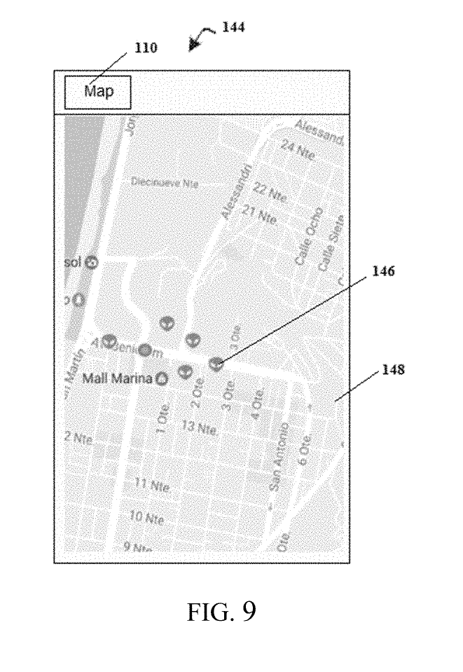

Referring now to the invention in more detail, in FIG. 9 there is an exemplary user interface allowing the user of the invention to see the location of other users of the invention on a map 144. The exemplary user interface allowing the user of the invention to see the location of other users of the invention on a map 144 includes a button “map” 110, a sign indicating the location of another user o the invention 146, and a map of the region in which the user of the invention resides 148.

In more detail, still referring to the invention of FIG. 9, the button “map” 110 is located on the top of the exemplary user interface allowing the user of the invention to see the location of other users of the invention on a map 144. If the user clicks on the button “map” 110, he will remain on the exemplary user interface allowing the user of the invention to see the location of other users of the invention on a map 144. The map of the region in which the user of the invention resides 148 is an exemplary road map. The map of the region in which the user of the invention resides 148 includes a sign indicating the location of another user of the invention 146.

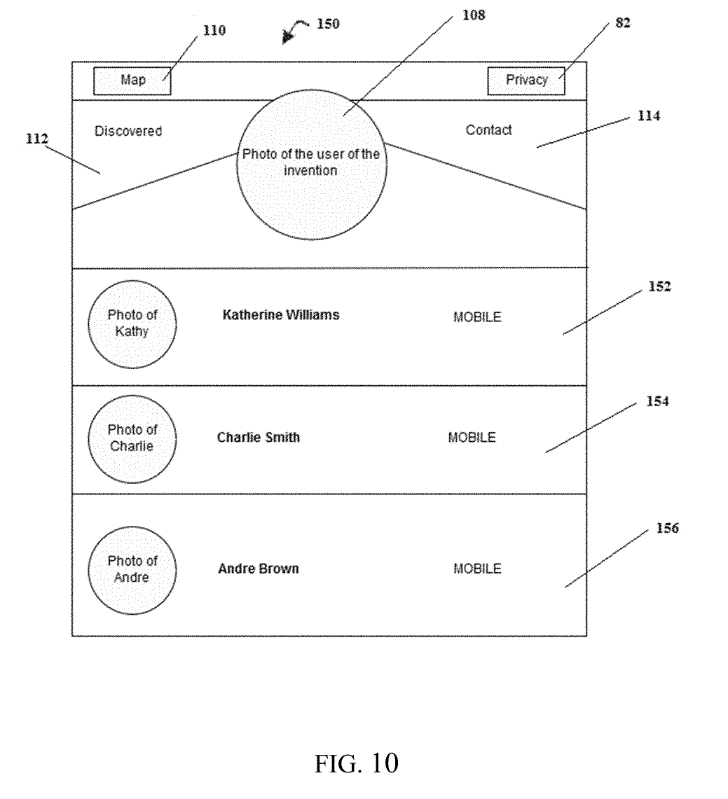

Referring now to the invention in more detail, in FIG. 10 there is an exemplary user interface allowing the user of the invention to contact other users 150. The exemplary user interface allowing the user of the invention to contact other users 150 includes a button “map” 110, a button “Privacy” 82, a button “Discovered” 112, a button “Contact” 114, a photo of the user of the invention 108, a section allowing the user of the invention to contact another user of the invention called Katherine Williams 152, a section allowing the user of the invention to contact another user of the invention called Charlie Smith 154, a section allowing the user of the invention to contact another user of the invention called Andre Brown 156.

In more detail, still referring to the invention of FIG. 10, the button “map” 110 and the button “Privacy” 82 are located on the top of the exemplary user interface allowing the user of the invention to contact other users 150. If the user of the invention clicks on the button “map” 110, he will be directed to the exemplary user interface allowing the user of the invention to see the location of other users of the invention on a map 144. If the user of the invention clicks on the button “Privacy” 82, he will be redirected to the exemplary user interface allowing the user of the invention to set privacy rules applying to his use of the invention 78. The photo of the user of the invention 108 can be either in black and white or color. If the user of the invention clicks on the button “Discovered” 112, he will remain viewing the exemplary user interface allowing the user of the invention to discover other users of the invention 106. If the user of the invention clicks on the button “Contact” 114, he will remain on the exemplary user interface allowing the user of the invention to contact other users 150. The user of the invention can use the exemplary user interface allowing the user of the invention to contact other users 150 to contact three exemplary users, namely, Katherine Williams, Charlie Smith, and Andre Brown. To contact Katherine Williams, the user of the invention needs to use the section allowing the user of the invention to contact another user of the invention called Katherine Williams 152. To contact Charlie Smith, the user of the invention needs to use the section allowing the user of the invention to contact another user of the invention called Charlie Smith 154. To contact Andre Brown, the user of the invention needs to use the section allowing the user of the invention to contact another user of the invention called Andre Brown 156.

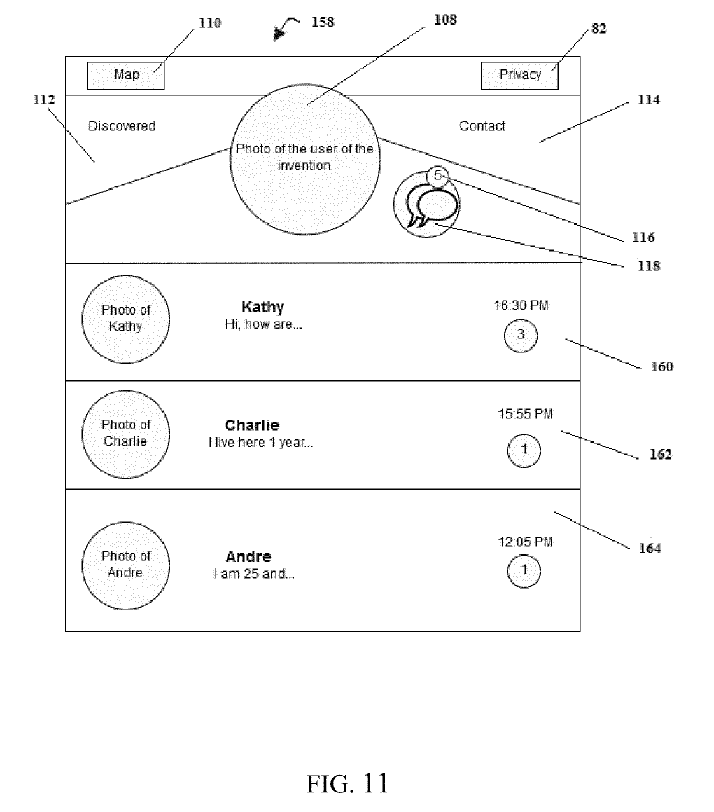

Referring now to the invention in more detail, in FIG. 11 there is an exemplary user interface allowing the user of the invention to view chat messages sent by other users of the invention 158. The exemplary user interface allowing the user of the invention to view chat messages sent by other users of the invention 158 includes a button “map” 110, a button “Privacy” 82, a photo of the user of the invention 108, a button “Discovered” 112, a button “Contact” 114, a field indicating the number of unread messages 116, a button redirecting the user of the invention to an exemplary user interface allowing the user of the invention to view chat messages sent by other users of the invention 118, a section allowing the user of the invention to view chat messages sent by a user of the invention called Kathy 160, a section allowing the user of the invention to view chat messages sent by a user of the invention called Charlie 162, and a section allowing the user of the invention to view chat messages sent by a user of the invention called Andre 164.

In more detail, still referring to the invention of FIG. 11, the button “map” 110 and the button “Privacy” 82 are located on the top of the exemplary user interface allowing the user of the invention to contact other users 158. If the user of the invention clicks on the button “map” 110, he will be directed to the exemplary user interface allowing the user of the invention to see the location of other users of the invention on a map 144. If the user of the invention clicks on the button “Privacy” 82, he will be redirected to the exemplary user interface allowing the user of the invention to set privacy rules applying to his use of the invention 78. The photo of the user of the invention 108 can be either in black and white or color. If the user of the invention clicks on the button “Discovered” 112, he will be redirected to the exemplary user interface allowing the user of the invention to discover other users of the invention 106. If the user of the invention clicks on the button “Contact” 114, he will be redirected to the exemplary user interface allowing the user of the invention to contact other users 150. The field indicating the number of unread messages 116 shows the number of unread messages which are received by the user of the invention. For example, if the user has five unread messages, the field indicating the number of unread messages 116 will show the number 5. If the user of the invention clicks on the button redirecting the user of the invention to an exemplary user interface allowing the user of the invention to view chat messages sent by other users of the invention 118, the user of the invention will remain on the exemplary user interface allowing the user of the invention to view chat messages sent by other users of the invention 158. The exemplary user interface allowing the user of the invention to view chat messages sent by other users of the invention 158 shows messages sent to the user of the invention by three exemplary users, namely, Kathy, Charlie, and Andrea. The messages sent by Kathy can be seen in the section allowing the user of the invention to view chat messages sent by a user of the invention called Kathy 160. The messages sent by Charlie can be seen in the section allowing the user of the invention to view chat messages sent by a user of the invention called Charlie 162. The messages sent by Andre can be seen in the section allowing the user of the invention to view chat messages sent by a user of the invention called Andre 164.

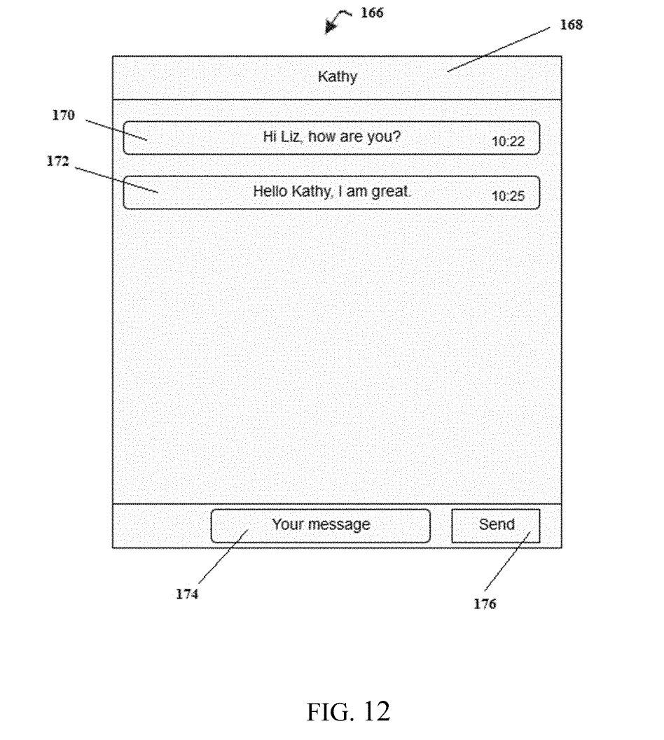

Referring now to the invention in more detail, in FIG. 12 there is an exemplary user interface allowing the user of the invention to chat with an individual user called Kathy 166. The exemplary user interface allowing the user of the invention to chat with an individual user called Kathy 166 includes a section containing the name of an individual user 168, an exemplary chat message sent by another user of the invention 170, an exemplary chat message sent by the user of the invention 172, a Tillable field allowing the user to type a message 174, a button “Send” allowing the user to send a message 176.

In more detail, still referring to the invention of FIG. 12, the section containing the name of an individual user 168 clearly indicates the title of the exemplary user interface allowing the user of the invention to chat with an individual user called Kathy 166. The exemplary chat message sent by another user of the invention 170 contains the text “Hi Liz, how are you?” The exemplary chat message sent by the user of the invention 172 contains the text “Hello Kathy, I am great”. The fillable field allowing the user to type a message 174 can be used by the user of the invention to type a message which can be sent to another user of the invention by using the button “Send” allowing the user to send a message 176.

The advantages of the present invention include, without limitation:
The invention allows users of the invention to discover other users of the invention on the basis of the location of such other users.
The invention allows users of the invention to discover other users of the invention on the basis of elements of the profiles created by such other users.
The invention allows users of the invention to contact other users of the invention by using a text chat or a mobile phone.
The invention allows users of the invention to discover other users of the invention in a privacy preserving way.
The invention allows users of the invention to see other others of the invention on a map.
The invention allows persons who look for service providers to find service providers.

In one embodiment of the invention, the present invention is a mobile application that, after being installed and activated on a mobile device, asks a user to verify his user phone number. When the user verifies his user phone number, the invention requests the user to activate his user account. When the user activates his user account, the invention requests the user to add information about himself. When the user adds information about himself, the invention requests the user to add information about his interests. When the user adds information about his interests, the invention requests the user to adjust his privacy settings. When the user adjusts his privacy settings, the invention allows the user to discover other users. When the user discovers other users, the invention allows the user to view the profiles of the other users. When the user views the profiles of other users, the invention allows the user to view other users on a map. When the user views other users on a map, the invention allows the user to contact other users. When the user contacts other users, the invention allows the user to view messages sent by other users. When the user views messages sent by other users, the invention allows the user to chat with individual users.

The embodiment is able to be implemented, for example, using a machine-readable medium or article which is able to store an instruction or a set of instructions that, if executed by a machine, cause the machine to perform the operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software.

The machine-readable medium or article is able to include, for example, any suitable type of memory unit, memory device, memory article, memory medium, storage device, storage article, storage medium and/or storage unit; for example, memory, removable or non-removable media, erasable or non-erasable media, write-able or re-write-able media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like.

The instructions are able to include any suitable type of code, for example, source code, compiled code, interpreted code, executable code, static code, dynamic code, or the like, and are able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A method for discovering and contacting users of a mobile application, the method comprising the following steps:
in a computer, asking an user to verify his user phone number;
when the user verifies his phone number, requesting the user to activate his user account;
when the user activates his user account, requesting the user to add information about himself;
when the user adds information about himself, requesting the user to add information about his interests;
when the user adds information about his interests, requesting the user to adjust his privacy settings;
when the user adjusts his privacy settings, allowing the user to discover other users;
when the user discovers other users, allowing the user to view the profiles of the other users;
when the user views the profiles of other users, allowing the user to view other users on a map;
when the user views other users on a map, allowing the user to contact other users;
when the user contacts other users, allowing the user to view messages sent by other users;
when the user views messages sent by other users, allowing the user to chat with individual users.

2. The method of claim 1, wherein the order of the steps differs from the order of the steps described in claim 1.

3. The method of claim 1, wherein the user is allowed to discover other users who are service providers.

4. The method of claim 1, wherein the order of the steps differs from the order of the steps described in claim 1 and the user is allowed to discover other users who are service providers.

5. The method of claim 1, wherein the privacy settings may enable the user of the invention to choose whether to be discovered by other users of the invention, to choose whether to add another user to the contact list if the number of the other user is in the address book of the user of the invention, to choose the gender of the users he wants to discover, to choose the age range of the users he wants to discover, to choose the nationality of the users of the invention he wants to discover, to choose the interests of the users he wants to discover, to choose whether to hide his location on a map, to choose whether to receive pop up notifications, to choose whether to hide his phone number, and to choose whether to hide his date of birth.

6. The method of claim 1, wherein the order of the steps differs from the order of the steps described in claim 1 and the privacy settings may enable the user of the invention to choose whether to be discovered by other users of the invention, to choose whether to add another user to the contact list if the number of the other user is in the address book of the user of the invention, to choose the gender of the users he wants to discover, to choose the age range of the users he wants to discover, to choose the nationality of the users of the invention he wants to discover, to choose the interests of the users he wants to discover, to choose whether to hide his location on a map, to choose whether to receive pop up notifications, to choose whether to hide his phone number, and to choose whether to hide his date of birth.

7. The method of claim 1, wherein the user is requested to add information about himself which includes a profile picture, name, gender, date of birth, nationality, profession, and email address.

8. The method of claim 1, wherein the order of the steps differs from the order of the steps described in claim 1 and the user is requested to add information about himself which includes a profile picture, name, gender, date of birth, nationality, profession, and email address.

9. The method of claim 1, wherein the profiles of other users include photos, names, email addresses, phone numbers, date of birth, nationality, and information about their interests.

10. The method of claim 1, wherein the order of the steps differs from the order of the steps described in claim 1 and the profiles of other users include photos, names, email addresses, phone numbers, date of birth, nationality, and information about their interests.

11. The method of claim 1, wherein the map on which the user can view other users includes signs indicating the location of other users of the invention.

12. The method of claim 1, wherein the order of the steps differs from the order of the steps described in claim 1 and the map on which the user can view other users include signs indicating the location of other users of the invention.

13. The method of claim 1, wherein, when the user discovers other users, he can see their location and the distance between the user and the location of the other users.

14. The method of claim 1, wherein the order of the steps differs from the order of the steps described in claim 1 and, when the user discovers other users, he can see their location and the distance between the user and the location of the other users.

15. The method of claim 1, wherein the user is allowed to discover other users who are service providers located within a predefined region or a region specified by the user of the invention.

16. The method of claim 1, wherein the order of the steps differs from the order of the steps described in claim 1 and the user is allowed to discover other users who are service providers located within a predefined region or a region specified by the user.
